(19) United States
(12) Patent Application Publication
(10) Pub. No.: US 2013/0125564 A1
(43) Pub. Date: May 23, 2013

(54) System and Method for Trapping and Collecting Volatile Compounds

(71) Applicant: Eric Jason BOOTH, Bozeman, MT (US)

(72) Inventor: Eric Jason BOOTH, Bozeman, MT (US)

(21) Appl. No.: 13/591,968

(22) Filed: Aug. 22, 2012

Related U.S. Application Data
(60) Provisional application No. 61/526,104, filed on Aug. 22, 2011.

(51) Int. Cl. B01D 8/00

(52) U.S. Cl. CPC B01D 8/00
USPC 62/55.5; 210/435

(57) ABSTRACT

A system and method for trapping and collecting volatile compounds is described. The system and method generally include a trapping column including adsorption materials positioned within a lumen of the trapping column, an oven for heating the trapping column, and a cold-trap condenser. When a sample containing a volatile compound is passed through the lumen of the trapping column, the volatile compound is captured on or in the adsorption material. The captured volatile compound is subsequently released from the trapping column by simultaneously heating the column in the oven while a gas is pushed through the lumen of the column, and the released volatile compound is collected in the cold-trap condenser.

### CROSS REFERENCE TO RELATED APPLICATIONS

This application claims the benefit of priority to U.S. Provisional Patent Application No. 61/526,104, filed on Aug. 22, 2011, which is herein incorporated by reference in its entirety.

### BACKGROUND OF THE INVENTION

It has been demonstrated recently that certain endophytic fungi are able to produce hydrocarbons and hydrocarbon derivatives having significant potential as fuel (Strobel et al., 2008, Microbiology 154:3319-3328; Griffin et al., 2010, Microbiology 156:3814-3829; Tomsheck et al., 2010, Microbial Ecology 60:903-914). These compounds are often represented by straight chained hydrocarbons, the acetyl esters of numerous straight and branched chained hydrocarbons, long chained alcohols and acids and a myriad of other substances including various mono and sesquiterpenoids. In addition, some endophytes produce benzene and reduced naphthalene related volatiles. More recently, some endophytes producing a wide range of cyclohexanes and derivatives thereof have been reported and these compounds have potential as fuels (U.S. Patent Application Publication No. 2011/0287471, Tomsheck et al., 2010, Microbial Ecology 60:903-914). One of these is Hypoxylon sp. that makes 1,8 cineole and some cyclohexane derivatives that have potential as fuels (Barton & Tjandra, 1989, Fuel 68:11-17; Sugito & Takeda, 1981, U.S. Pat. No. 4,297,109). These compounds are generally having their origins via the condensation of two isoprenes and are thus monoterpenoids (Croteau et al., 1988, J. Biol. Chem. 263:15449-15453). They, along with certain representative (reduced) substances in the other classes of molecules mentioned above, are found in the world's transportation fuels, such as gasoline, diesel and jet fuel.

As various fungi are being isolated and tested for their abilities to produce fuel related compounds, the solid phase microextraction (SPME) fiber technique is the one most commonly used to assess hydrocarbon production by the microbe. The fiber is exposed to the headspace of fungal cultures. Subsequently, the trapped contents are analyzed by GC/MS (Strobel et al., 2001, Microbiology 154:3319-3328; Ezra et al., 2004, Microbiology 150:4023-4031). Initially, some idea of the nature and abundance of the fungal volatiles produced in culture is obtained. Usually, with this technique, identification of a volatile can be rapidly and accurately made by virtue of a high quality match of the fungal MS data with its corresponding spectrum in the NIST or other data bases. However, in some cases the quality of a NIST data base match is poor, suggesting that compound identity cannot be made or even assumed. Thus, there is a need to have a preparative methodology to collect substantial amounts of fungal volatiles making way for the ultimate isolation and identification of unknown compounds in the fungal volatile mixture. Such a technique may also easily allow for the rapid assessment of the quantity of fuel compounds produced by microorganisms such as fungi throughout the fermentation processes.

Because fungi are capable of producing biologically active volatiles, there is an obvious need to obtain measurable condensed material for use in the bioassay process. Also, a trapping device suitable for any sort of volatile compounds would have enormous utility in the collection of plant fragrances, or other emissions from biological sources where identification, mode of action and other questions are being asked. Unfortunately, traditional attempts to collect such volatiles via condensation methodologies usually result in large amounts of unwanted water in the trapping device, and the amount of resulting chemical products are usually diminishingly small and are not readily separable from the aqueous phase. Thus, there is a need in the art for an improved trapping device, system and method for capturing volatile organic chemicals. The present invention addresses this unmet need in the art.

### BRIEF SUMMARY OF THE INVENTION

The present invention provides a device for trapping volatile compounds.

In one embodiment, the device comprises a column having an inner chamber and at least one adsorption material. In another embodiment, the device comprises a column having an inner chamber separated into at least two compartments and at least two different adsorption materials where each of the at least two compartments of the column contains one of the at least two different adsorption materials. In one embodiment, the at least two compartments are aligned sequentially, such that when a sample containing a volatile compound is passed through the inner chamber of the column, the sample passes through each compartment sequentially.

In one embodiment, one of the at least two different adsorption materials is carbon black. In another embodiment, one of the at least two different adsorption materials is Carbotrap C. In another embodiment, one of the at least two different adsorption materials is Carbotrap B.

In one embodiment, the Carbotrap C material is placed within the column upstream of the Carbotrap B material, such that when a sample containing a volatile compound is passed through the inner chamber of the column, the sample first contacts the Carbotrap C material and subsequently contacts the Carbotrap B material.

In some embodiments, each compartment is separated by a screen.

In one embodiment, the volatile compound is a volatile organic compound (VOC) produced by a microorganism. In some embodiments, the VOC is a hydrocarbon or hydrocarbon derivative.

In another aspect, the present invention provides a system for trapping and collecting volatile compounds. The system comprises a trapping column including at least one adsorption material positioned within a lumen of the trapping column, an oven for heating the trapping column, and a cold-trap condenser. The system further comprises that when a sample containing at least one volatile compound is passed through the lumen of the trapping column, the at least one volatile compound is captured on or in the at least one adsorption material. The system further comprises that the captured at least one volatile compound is released from the trapping column by simultaneously heating the column in the oven while a gas is pushed through the lumen of the column, and collecting the at least one volatile compound released from the trapping column in the cold-trap condenser.

In one embodiment, the column is heated in the oven to at least 50 C. In another embodiment, the cold-trap condenser is cooled to at least 0° C. In one embodiment, the yield of collected volatile compound is at least 10% of the amount of volatile compound initially passing through the trapping column.

In one embodiment, the at least one volatile compound is a VOC produced by a microorganism. In one embodiment, the VOC is produced via liquid phase fermentation.

In one embodiment, the VOC is produced via solid phase fermentation. In another aspect, the present invention provides a method of trapping and collecting volatile compounds. The method comprises passing a sample having at least one volatile compound through a column containing at least one adsorption material, trapping the at least one volatile compound on or in the at least one adsorption material, passing a gas through the column while simultaneously heating the column to release the at least one volatile compound from the adsorption material, and collecting the at least one volatile compound released from the adsorption material in a cold-trap condenser. In one embodiment, the column is heated in the oven to at least 50° C. In one embodiment, the cold-trap condenser is cooled to at least 0° C. In one embodiment, the yield of collected volatile compound is at least 10% of the amount of volatile compound initially passing through the trapping column.

### BRIEF DESCRIPTION OF THE DRAWINGS

For the purpose of illustrating the invention, there are shown in the drawings embodiments which are presently preferred. However, the invention is not limited to the precise arrangements and instrumentalities of the embodiments shown in the drawings.

FIG. 1, comprised of FIGS. 1A-1C, is a series of illustrations of exemplary column assemblies. FIG. 1A is a schematic of a fully assembled column of FIG. 1, in accordance with the present invention. FIG. 1B is a schematic of an alternative exemplary column assembly of FIG. 1, containing two end caps, with one secured at each end of the column. FIG. 1C is a photograph of an exemplary column assembly, in accordance with the present invention. Included in FIG. 1C is a view of the basic components of the column assembly, showing the column, the end cap, and the optional mesh screen which may be present within the column.

FIG. 2 is a schematic of an exemplary purging system setup for the removal and collection of the trapped volatile organic compounds, in accordance with the present invention. The column assembly is heated within an oven, permitting the desorption of the volatile organic compounds from the adsorption material contained within the column assembly. Gas enters the oven and flows through the column assembly to elute the desorbed volatile organic compounds out of the column. The volatile organic compounds are then collected as they condense inside a container which is submerged in a cold trap. The volatile organic chemicals are collected as they condense inside a container which is submerged in the cold trap.

FIG. 3 is a schematic of the cold trap component of the purging system of FIG. 2 used for the collection of volatile organic compounds.

FIG. 4, comprising FIGS. 4A and 4B, illustrates an exemplary trapping system setup for the trapping of volatile organic compounds, in accordance with the present invention. FIG. 4A is a schematic of the trapping system, where volatile organic compounds produced from the fermentation culture are collected and trapped on the surface of the adsorption material contained within the column assembly. FIG. 4B is a photograph of a shaking culture of Hypoxylon sp. used in Example 1 to test the effectiveness of various materials to trap the VOCs produced by the fungus.

FIG. 5 is a block diagram of an exemplary method of trapping and collecting volatile organic compounds in accordance with the present invention.

FIG. 6 is a series of graphs of PTR-MS data illustrating the retention efficiency of the fungal volatiles from Hypoxylon sp. for the two trapping materials. The mass spectra recorded from the effluent exiting the trap (grey bars) have been superimposed onto the mass spectra from the fungal gas mixture entering the trap (black bars). Ions appearing as black bars reflect the presence of compounds that were retained by the traps, whereas ions appearing as grey bars indicate compounds whose concentrations were unaffected by passage through the trap. Both traps were found to be effective in the retention of high molecular weight components that produce the ions observed at m/z 121 and m/z 137. The action of the bentonite shale trap is nonselective and shows retention of all the fungal volatiles. The major ions are annotated and have been tentatively identified. The ion intensities have been computed into their equivalent concentrations.

FIG. 7 is a photograph of a SEM of the bentonite shale used in these experiments. The plate-like appearance of the material can be observed, in addition to the presence of many pores and other openings in the matrix.

FIG. 8 is a series of spectra of two positive ion ToF-SIMS spectra comparing organic mass fragments in the mass region from 110 to 240 amu on bentonite. The spectrum shown in the top panel was obtained from the surface of an activated shale particle exposed to the gaseous fungal environment. The spectrum in the bottom panel was obtained from a control shale particle, activated by heating but exposed to the laboratory atmosphere only.

### DETAILED DESCRIPTION

It is to be understood that the figures and descriptions of the present invention have been simplified to illustrate elements that are relevant for a clear understanding of the present invention, while eliminating, for the purpose of clarity, many other elements found in volatile compound trapping and collection systems, and their methods of use. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. It should be appreciated that the disclosure herein is directed to all such variations and modifications to such elements and methods known to those skilled in the art.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

As used herein, an “organic compound” generally means a carbon-based molecule. However, as used herein, this term does not include carbon-based molecules that are typically are considered inorganic, such as carbon monoxide or carbon dioxide.

As used herein, “volatile” means that a chemical compound has either: (a) a vapor pressure under standard laboratory conditions of at least 5 ton; or (b) an evaporation rate relative to n-butyl acetate of at least 0.5. Such a volatile chemical compound can vaporize significantly and enter the atmosphere. At any given temperature for a particular chemical compound, there is a pressure at which the gas of that compound is in dynamic equilibrium with its liquid or solid forms. The equilibrium vapor pressure is an indication of a liquid's evaporation rate. Evaporation rates generally have an inverse relationship to boiling points; that is, the higher the boiling point, the lower the rate of evaporation. The general reference material for evaporation rates is n-butyl acetate (commonly abbreviated BuAc). Whenever a relative evaporation rate is given, the reference material must be stated. ASTM International (originally known as the American Society for Testing and Materials) has developed a standard test method, D3539-87 (2004) Standard Test Methods for Evaporation Rates of Volatile Liquids by Shell Thin-Film Evaporometer.

As used herein, “VOC” refers to a volatile organic compound. A particular VOC can have a normal physical state that is a liquid or a gas under standard laboratory conditions. For example, benzene is a liquid under standard laboratory conditions, and it has an evaporation rate into the atmosphere under standard laboratory conditions. Methane is a gas under standard laboratory conditions, that is, its boiling point is lower than the temperature of standard laboratory conditions. The “normal boiling point” (also known as the atmospheric boiling point or the atmospheric pressure boiling point) of a liquid is the special case in which the vapor pressure of the liquid equals the defined atmospheric pressure at sea level, 1 atmosphere. Accordingly, as used herein, “volatile organic compound” (VOC) includes chemicals such alkanes, alcohols, aldehydes, ketones, and other “light” hydrocarbons. Non-limiting examples of VOCs also include some aromatic compounds, such as benzene, toluene, ethyl benzene, and xylenes.

As used herein, the term “hydrocarbon” generally refers to a chemical compound that consists of the elements carbon (C) and hydrogen (H). All hydrocarbons consist of a carbon backbone and atoms of hydrogen attached to that backbone. Hydrocarbons are of prime economic importance because they encompass the constituents of the major fossil fuels (coal, petroleum, natural gas, etc.) and biofuels, as well as plastics, waxes, solvents and oils.

The term “fungus” or “fungi” includes a wide variety of nucleated, spore-bearing organisms that are devoid of chlorophyll. Examples of fungi include yeasts, molds, mildews, rusts, and mushrooms.

The term “bacteria” includes any prokaryotic organism that does not have a distinct nucleus.

The term “microorganism” or “microbe” refers to any unicellular or multicellular microscopic organism, including all natural or genetically modified bacteria, algae, fungi, protozoa or other microscopic plants and animals.

The term “isolated” means altered or removed from the natural state or biological niche through the actions of a human being.

The term “culturing” refers to the propagation of organisms on or in solid or liquid media of various kinds.

The term “metabolite” refers to any compound, substance or byproduct (including a volatile) of a fermentation of a microorganism that has a biological activity.

The term “instructional material,” as that term is used herein, includes a publication, a recording, a diagram, or any other medium of expression which can be used to communicate the usefulness or procedural steps of the invention.

The term “Carbotrap B” refers to carbon adsorbents fabricated from graphitized carbon black (20/40 mesh), with a BET surface area of 100 m²/g and a density of 0.37 g/mL. The material is commercially available and may be purchased from Supelco (Bellefonte, Pa.).

The term “Carbotrap C” refers to carbon adsorbents fabricated from graphitized carbon black (20/40 mesh), with a BET surface area of 10 m²/g and a density of 0.68 g/mL. The material is commercially available and may be purchased from Supelco (Bellefonte, Pa.).

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Further, all numerical designations, e.g., pH, temperature, time, concentration, and molecular weight, including ranges, are approximations which may be varied (+) or (−) by increments of 0.1. It is to be understood, although not always explicitly stated that all numerical designations are preceded by the term “about”. It also is to be understood, although not always explicitly stated, that the reagents described herein are merely exemplary and that equivalents of such are well known in the art.

### DESCRIPTION

As contemplated herein, the present invention relates to a device and system for the trapping and recovering volatile compounds, such as volatile organic compounds (VOCs) produced by microorganisms or other biological sources, such as trees, soil, or animals. The trapping column includes a central tube having a multi-compartment inner chamber that contains an adsorption material in each compartment, whereby volatile compounds within a sample are captured on or in the adsorption materials when the sample is passed through the inner chamber. The volatile compounds remain trapped within the column until such time as the column is heated, effectively releasing the volatile compounds from the adsorption material. The released compounds are subsequently collected in a cold trap condenser. In some embodiments, the central tube comprises a single compartment inner chamber. In other embodiments, the central tube comprises a multiple compartment inner chamber.

The present invention also provides methods of trapping and collecting volatile compounds. The methods include the steps of passing a gaseous sample containing at least one volatile compound through a trapping column containing at least one adsorption material such that the volatile compounds within the sample are captured on or in the adsorption material, simultaneously heating the column while purging the column with a gas, and collecting the volatile compounds in a cold trap condenser.

### Trapping Columns

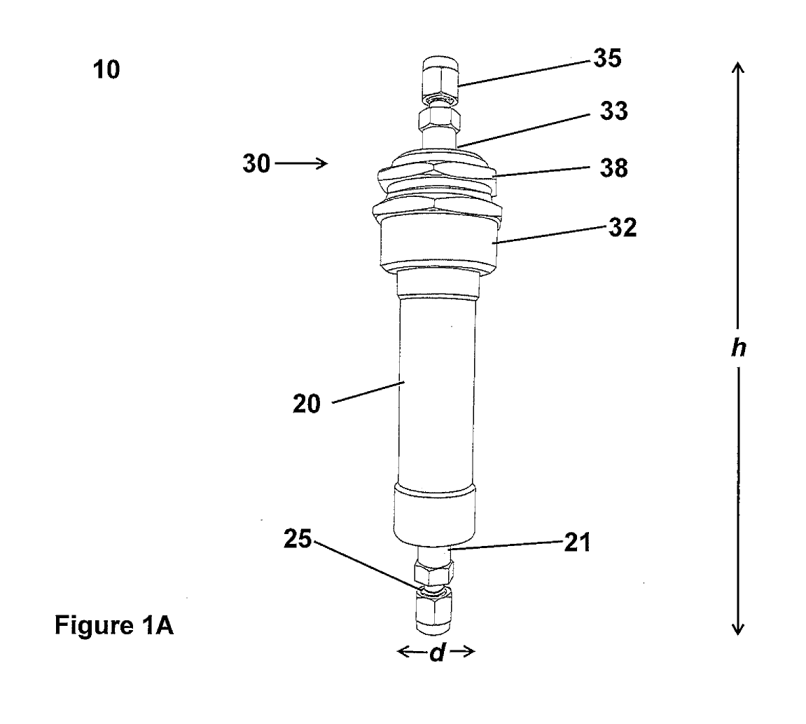

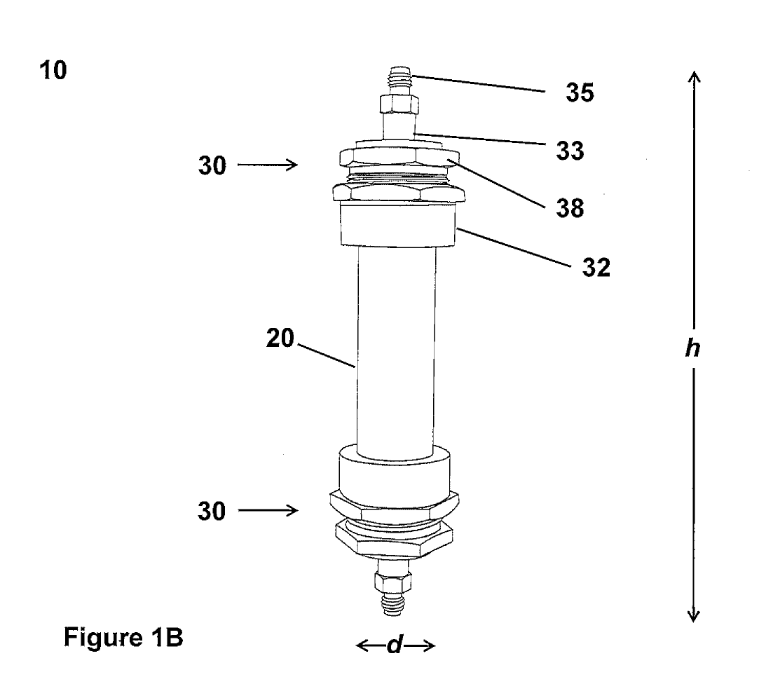

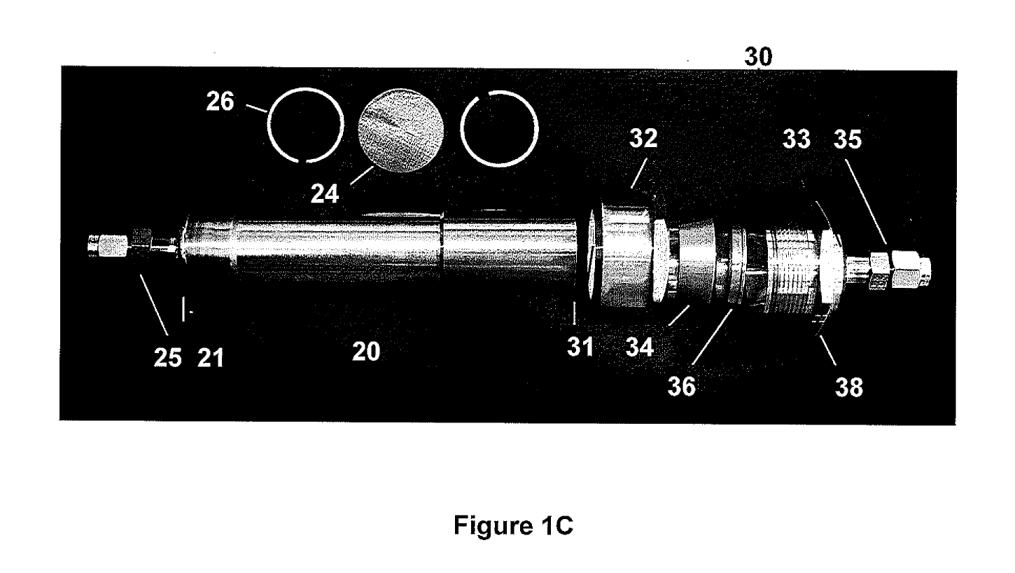

Referring now to FIGS. 1A-1C, the present invention includes a sealable column suitable for trapping volatile compounds, such as VOCs produced by microorganisms. Accordingly, the present invention may be used for any set up where the trapping and recovery of VOCs is desired. In certain embodiments, the VOCs may be hydrocarbons, and may be useful for the production of biofuels, plastics, plasticizers, antibiotics, rubber, fuel additives, and/or adhesives. As will be appreciated by one of skill in the art, hydrocarbons can also be used for electrical power generation and heating. The chemical, petrochemical, plastics and rubber industries are also dependent upon hydrocarbons as raw materials for their products. It should be appreciated that while the present invention and experimental examples focus on the trapping and collecting of VOCs produced by fungi, the present invention is not limited to any particular type and or source of volatile compounds within a sample. Accordingly, the present invention is suitable for capturing any and all volatile chemicals or compounds from any source or sample, as would be understood by those skilled in the art.

As illustrated in FIGS. 1A-1C, trapping column 10 may include central column or tube 20 having inlet and outlet ports 21 and 23, respectively, and an inner chamber within the lumen of central column 20 (not shown); a releasable cap 30 on one end (FIGS. 1A and 1C) or both ends (FIG. 1B) of central column 20; and a fitting or adapter 35 at each end of trapping column 10 for creating a gas tight seal and/or connection to additional equipment, such as a ⅛ inch Swaglok™ fitting. Column 10 may be fabricated from any material known in the art to be sufficiently thermally stable as to withstand the heating process required for elution of the VOCs from the adsorption material, as described elsewhere herein. In a preferred embodiment, column 10 is fabricated from stainless steel.

As illustrated, end cap 30 may include lock ring 32, outlet port 33, primary collet 34, secondary collet 36, and end cap 38. End cap 30 may further contain a passage, which generally forms a passage in communication with the inner chamber of column 20, permitting gas flowing from the inner chamber of column 20 to exit the column assembly. The passage permits untrapped gases to pass through the column assembly during trapping. Additionally, the passage permits the trapped volatiles to be released from the column assembly upon elution from the adsorption materials. End cap 30 may further be removable, providing access to the inner chamber of central column 20. Upon removal of the end cap, adsorption material may be placed within the inner chamber. Alternatively, the adsorption material contained within the inner chamber may be removed and/or replaced with a new and/or different type of adsorption material. Access to the inner chamber also facilitates the cleaning of the column assembly, if so desired. Lock ring 32 engages central column 20 and end cap 30 in order to couple central column 20 to end cap 30 and form a gas tight seal. As contemplated herein, a plurality of collets may be present in end cap 30. The collets may be cylindrical in shape and arranged in a row, wherein the first collet is the row is engaged with lock ring 32, while the last collet in the row is engaged with end cap 38. In a preferred embodiment, end cap 30 is comprised of a primary collet 34 and secondary collet 36, wherein primary collet 34 is engaged with lock ring 32 and secondary collet 36, while secondary collet is engaged with primary collet 34 and end cap 38. Outlet port 33 may be attached to gas tight seal 35 to maintain columnar pressure and/or prevent leakage of VOCs from the column. In one embodiment, gas tight seal 35 is a ⅛ inch Swaglok™ fitting. When operated according to the preferred method, the VOCs exit the column assembly through gas tight seal 35. As depicted in FIG. 1B, and alternative embodiment of the present invention may have more than one end cap 30 attached to column 20.

The inner chamber of central column 20 may include one or more compartments, where each compartment contains an adsorption material for capturing volatile compounds on or in the material. When the inner chamber contains two or more compartments, those compartments may be aligned sequentially, such that when a sample is passed through the inner chamber, the sample also passes through the various adsorption materials sequentially. In certain embodiments, the compartments may be separated by a screen or filter, such as mesh screen 24, which may be secured within the inner chamber by snap rings 26 positioned on either side of mesh screen 24 (FIG. 1C). It should be appreciated that any number of screens or filters may be used between any adjacent compartments within the inner chamber of central column 20.

The adsorption materials may be any kind of material suitable for binding or otherwise capturing volatile compounds. Examples of adsorption materials include molecular sieves, such as zeolites, alumina, silica, and activated carbon. Further examples are oxides, carbonates, and hydroxides of alkaline earth metals such as Mg, Ca, Sr, and Be or alkali metals such as K or Ce. Still further examples include metal phosphates, such as phosphates of titanium and zirconium. In some embodiments, the adsorption material has a surface chemistry that enhances the interaction of the adsorption material with the adsorbent. In other embodiments, the adsorption material has a size that enhances the interaction of the adsorption material with the adsorbent. In some embodiments, the micro- and nanostructure of the adsorption material influences the ability of the adsorption material to retain a particular volatile compound. In certain embodiments, the adsorption material may be Carbotrap B, Carbotrap C, bentonite shale, carbon black, or any combination thereof. For example, Carbotrap B and C are selective for hydrocarbons and hydrocarbon derivatives. Carbotrap B material effectively traps low molecular weight VOCs, while Carbotrap C material has an affinity for higher molecular weight VOCs. In other embodiments, the adsorption materials may capture about 1% of their weight in VOCs. Further, the adsorption material should be of sufficient thermal stability to withstand the heating process required to elute the VOCs from the adsorption material as described elsewhere herein. It should be appreciated that when column 10 includes a multi-compartment inner chamber, one or more types of adsorption materials may be placed in each compartment, and each compartment may have the same or different combinations of such materials. Accordingly, particular combinations of materials may be used to provide a column having customized trapping characteristics for any particular type or panel of volatile compounds to be trapped and ultimately collected.

As contemplated herein, column 10 may be of any size and shape, provided that when assembled, a gas tight seal is formed to prevent the leakage of gases out of the column, and to create a uniform flow and distribution of the positive pressure which passes through the adsorption material to avoid channeling. For example, column 10 may be generally cylindrical, having an outer diameter d, a length of h, and an inner diameter of the inner chamber (not shown). In one embodiment, central column 20 has an outer diameter of about 2.54 cm, a length of about 12 cm, and an inner diameter of about 22 mm. The volumetric capacity of central column 20 can be varied by providing a column of greater length and/or diameter to assure that the capacity of the adsorption material is not exceeded for the expected amount of volatile compound to be trapped. The size of column assembly 10 may also be varied to accommodate any system or desired use, as would be understood by one skilled in the art.

In use, positive pressure may be applied to push the VOCs through column assembly 10, whereupon the VOCs enter the inner chamber of column 20. The VOCs are adsorbed onto the surface of the adsorption material contained in the inner chamber and trapped within the column. The positive pressure may be generated by the flow of a gas through the column assembly. Any inert gas may be used in the present invention. In one embodiment, the gas is anhydrous nitrogen gas. In another embodiment, the gas is helium. In another embodiment, the gas is argon. In another embodiment, the gas is atmospheric air. The VOCs remain adsorbed onto the surface of the adsorption material until recovery of the VOCs is desired. Heat may then be applied to column assembly 10 to facilitate desorption of the VOCs from the adsorption material. Simultaneously, gas may be flown through column assembly 10 to elute the desorbed VOCs by pushing VOCs from the inner chamber of column 20 through end cap 30, whereupon the VOCs exit the column assembly. The VOCs may be collected in a container submerged in a cold bath, as would be understood by one skilled in the art.

### Elution and Collection of Trapped Volatile Compounds

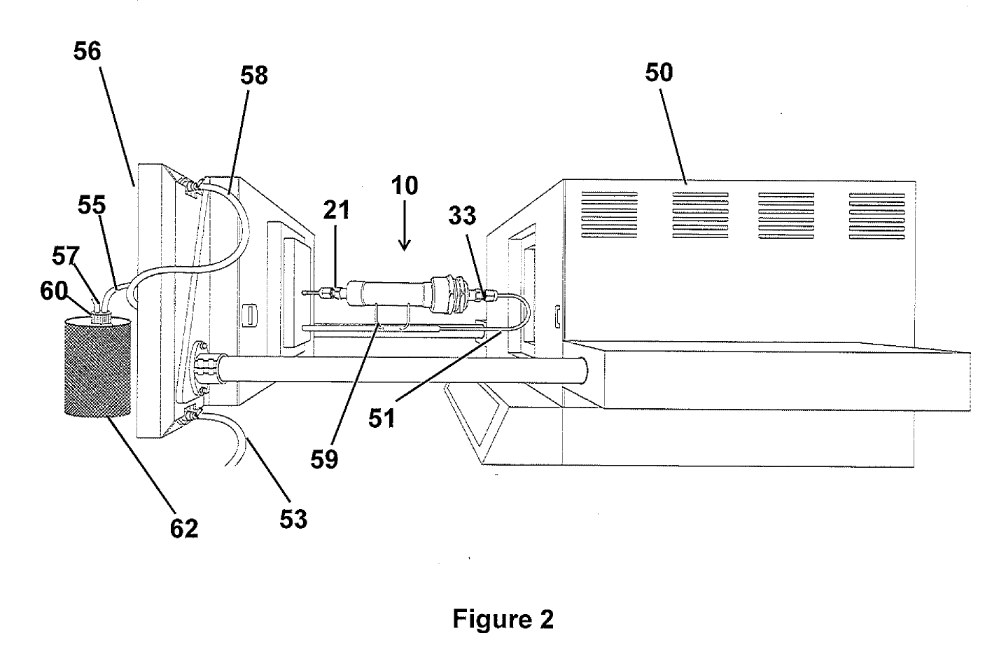

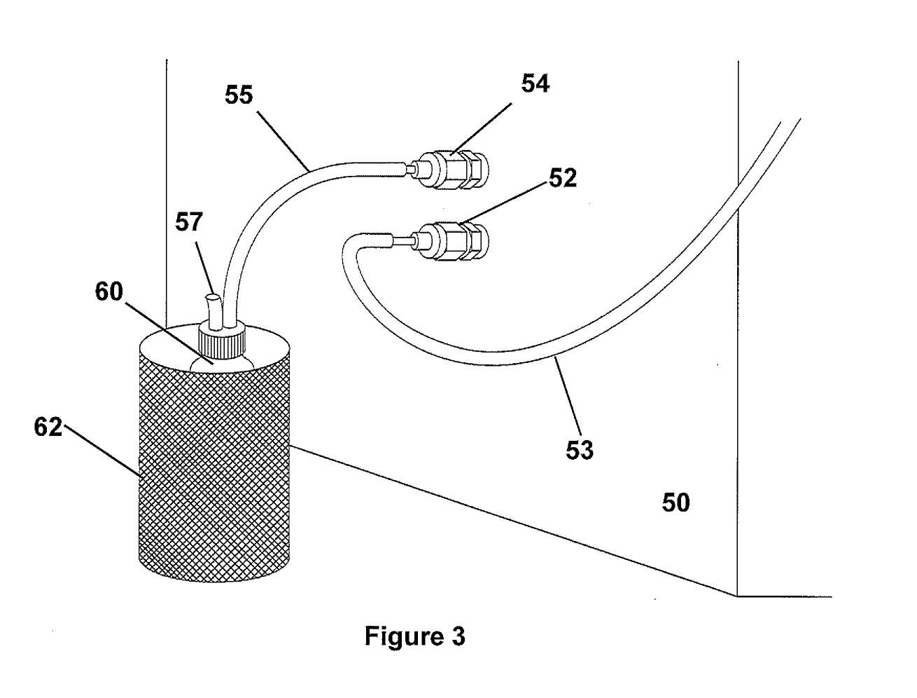

FIGS. 2 and 3 depict an exemplary system for collection of volatile organic compounds using the present invention. Column assembly 10 is detached from the collection assembly depicted in FIG. 2 and placed on rack 59 within oven 50 for heating. A flow of gas travels through tube 53 and enters gas flow rate indicator 56, which measures the flow rate of the gas, as would be understood by one skilled in the art. The use of a flow rate indicator provides reproducibility of the reaction conditions by ensuring repeatability of the aeration. The gas flows through tube 58 and enters oven 50 through inlet 52. Gas enters column assembly 10 through inlet port 21 from tubing connected to inlet 52 and exits through outlet port 33 as an effluent containing the desorbed VOCs. The effluent travels through tube 51 and exits oven 50 through tube 55.

As contemplated herein, tubing may be any type of adapter suitable for facilitating such connection, as would be understood by those skilled in the art. Tubing may be composed of any material, as would be understood by one skilled in the art. As tube 51 is contained within oven 50, it should be constructed from material with sufficient thermal stability over the temperature range of the heating processes. In one embodiment, tube 51 is constructed from stainless steel tubing. Preferably, tubes 53, 55, and 58 are constructed from material which does not react with the VOCs. In one embodiment, tube 53, 55, and 58 are constructed from Tygon tubing.

As would be understood by one skilled in the art, the temperature required for the heating process and desorption of the VOCS from the adsorption material may vary depending upon the properties of the VOCs and/or the properties of the adsorption material. The temperature may be increased slowly over time, resulting in a range of temperatures throughout the duration of the heating process. In some embodiments, multiple temperatures are used sequentially, resulting in a separation of the compounds, as different VOCs elute at different temperatures. By way of non-limiting example, fractional distillation techniques can be used to separate compounds using a sequence of multiple temperatures, as would be understood by one skilled in the art. In one embodiment, the temperature is of a range from 30° C. to 300° C. In another embodiment, the temperature is of a range from 30° C. to 250° C. In another embodiment, the temperature is of a range from 30° C. to 180° C. In another embodiment, the temperature is of a range from 30° C. to 150° C. In a specific embodiment, the temperature is 250° C.

The duration of the heating process may also vary depending on the properties of the VOCs, as would be understood by a skilled artisan. In one embodiment, the duration of the heating process is 24 hours. In another embodiment, the duration of the heating process is 12 hours. In another embodiment, the duration of the heating process is 6 hours. In another embodiment, the duration of the heating process is 3 hours. In another embodiment, the duration of the heating process is 1 hour.

The effluent containing VOCs exits oven 50 by way of tube 55 and is directed into container 60, which is submerged in a cold trap 62. As the effluent passes through container 60, the volatile organic compounds are subjected to a cooling process whereupon they are condensed and collected within container 60, while the gas is vented out of the assembly through vent 57. Cold trap 60 should be of a temperature low enough to condense the VOCs which flow through container 60. In one embodiment, the temperature of the cold trap may be from 0° C. to −200° C. In one embodiment, the temperature of the cold trap is at least of a temperature below 0° C. In another embodiment, the temperature of the cold trap is at least of a temperature lower than −20° C. In another embodiment, the temperature of the cold trap is at least of a temperature lower than −40° C. In another embodiment, the temperature of the cold trap is at least of a temperature lower than −78° C. In a preferred embodiment, the temperature of the cold trap is at least of a temperature lower than −196° C. In a preferred embodiment, container 60 is submerged in liquid nitrogen. The duration of the cooling process may vary depending on the amount of time required to elute the VOCs from the adsorption material, as would be understood by a skilled artisan. In one embodiment, the duration of the cooling process is 24 hours. In another embodiment, the duration of the cooling process is 12 hours. In another embodiment, the duration of the cooling process is 6 hours. In another embodiment, the duration of the cooling process is 3 hours. In another embodiment, the duration of the cooling process is 1 hour.

The percent recovery of VOCs from column assembly 10 is equal to (mass of VOCs collected in container 60 following elution and removal of trapped VOCs from column assembly 10)/(mass of VOCs entering column assembly 10)×100. In one embodiment, the percent recovery is ≧99%. In one embodiment, the percent recovery is ≧90%. In one embodiment, the percent recovery is ≧80%. In one embodiment, the percent recovery is ≧70%. In one embodiment, the percent recovery is ≧60%. In one embodiment, the percent recovery is ≧50%. In one embodiment, the percent recovery is ≧40%.

### Generation of Volatile Compounds

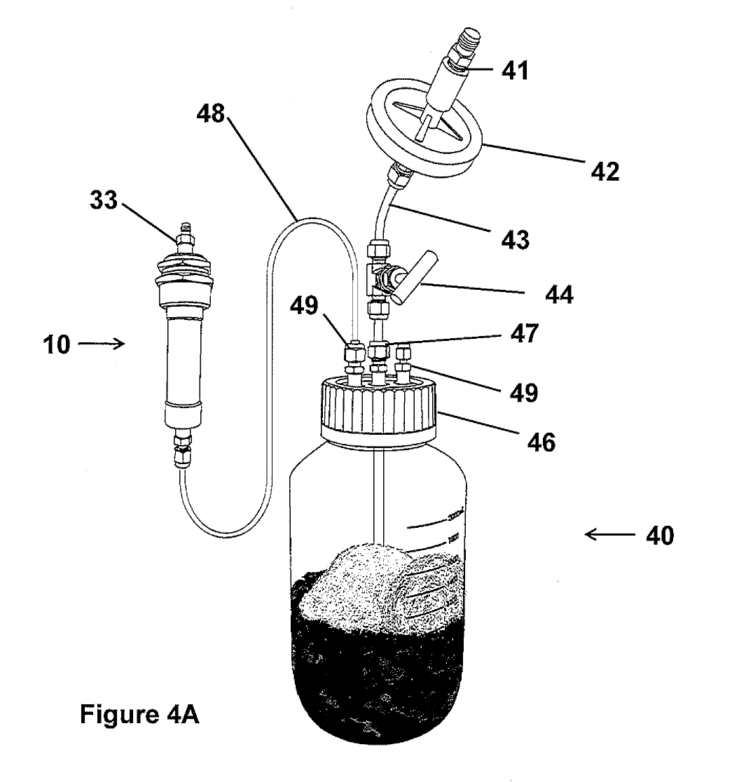

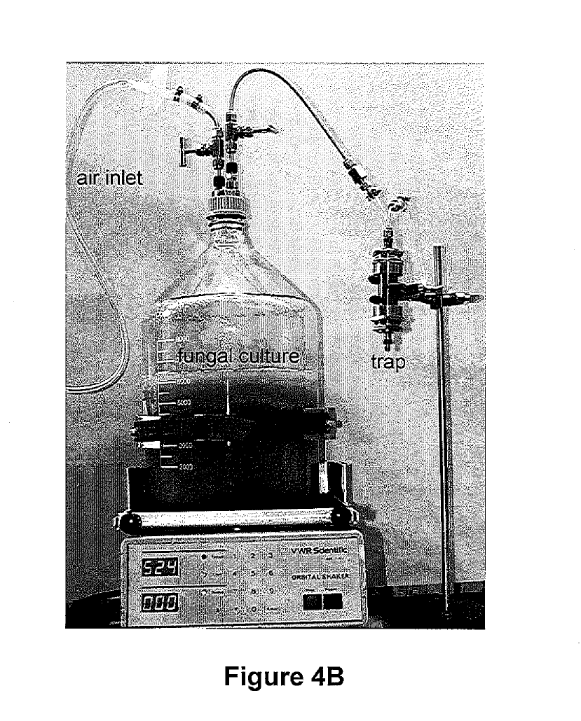

FIGS. 4A and 4B depict an exemplary system for the trapping of volatile organic compounds using the present invention. Volatile organic compounds produced within vessel 40 containing a solid state fermentation system are collected within column assembly 10. It should be appreciated that the present invention is not limited to the trapping of VOCs produced by microorganisms, such as fungi. As contemplated herein, the present invention may be used with any system in which VOCs are produced. Examples of systems include, but are not limited to, solid state fermenters or submerged (liquid state) fermenters. In some embodiments, vessel 40 is constructed of Pyrex glass or polycarbonate, but other suitable materials are optionally used to construct the sample vessels. For example, plastic, ceramic, metal, e.g., aluminum, or any other material is optionally used that is non-reactive to fermentation medium. In a preferred embodiment, vessel 40 is composed of a thermostable material and may be autoclavable. Examples of autoclavable materials include, but are not limited to, glass, ceramics, polypropylene, polymethylpentene, polycarbonate, acetal products, and polysulfone products. During the fermentation process and/or the collection of VOCs, vessel 40 may undergo mixing to provide equal distribution of the compositions contained within. in one embodiment, vessel 40 is mixed by mounting the vessel on a shaker. In one embodiment, vessel 40 is mixed using magnetic stir bars.

Vessel 40 may be sealed with a cap 46, which contains at least one inlet 47 and at least one outlet 49. In one embodiment, cap 46 contains one inlet 47 and two outlets 49. The VOCs exit vessel 40 through outlet 49 and are directed toward column assembly 10 through tube 48. Tube 48 is composed of a thermostable material and may be autoclavable, as would be understood by one skilled in the art. In one embodiment, tube 48 is comprised of short stainless steel lines and Tygon tubing. A flow of gas enters the system through inlet 41. The flow of gas may pass through a filter 42 to prevent the introduction of any contaminants or particles into the fermentation broth. The filter may be any filter suitable for the removal of contaminants or particles, as would be understood by one skilled in the art. In one embodiment, the filter is a 0.2 micron Pall-Acro-50 filter. The gas exits the filter and enters vessel 40 through tube 43. The system may optionally contain a stopcock 44, which can be closed to stop the flow of gas into system if so desired. The flow of gas enters the system through inlet 41, flowing into the fungal head space of vessel 40 and pushing the VOCs into column assembly 10 through tube 48, where the VOCs are adsorbed and trapped. The gas is vented out of the system through outlet port 33.

### Methods of Trapping and Collecting Volatile Compounds

As contemplated herein, the present invention provides methods for the trapping and collection of volatile organic compounds. One embodiment of the present invention includes a method for the trapping of volatile organic compounds. In a preferred embodiment, an inert gas containing VOCs is passed through central column 20 of trapping column assembly 10. The VOCs passing through the column assembly are adsorbed and trapped upon the surface of the adsorption material contained within the inner chamber of central column 20 and/or within the pore space of the adsorption material contained within the inner chamber of central column 20. In a preferred embodiment, the inner chamber is separated into at least two compartments. Each compartment may comprise a different adsorption material. In a preferred embodiment, the trapping column comprises at least two different adsorption materials. In a preferred embodiment, the at least two different adsorption materials are Carbotrap C and Carbotrap B.

Prior to the trapping of the VOCs, column assembly 10 may be pre-conditioned to remove any previously adsorbed VOCs and to activate the adsorption materials for the trapping process, as would be understood by one skilled in the art. In one embodiment, column assembly 10 is pre-conditioned by heating and applying a flow of gas. In a preferred embodiment, the pre-conditioning comprises heating the column assembly to 250° C. for at least 1 hour.

The present invention also provides a method of eluting and collecting volatile organic compounds. The column assembly of the present invention is uniquely structured for the elution of VOCs from the surface of the adsorption material. Heat may be applied to the column assembly to facilitate the elution of the VOCs from the adsorption material. Any type of heating method may be used to heat the column assembly. In one embodiment, a temperature programmable oven is used to heat the column assembly (FIGS. 2 and 3). It should be appreciated that any method which facilitates the elution of the VOCs from the adsorption material may be used in the present invention. In one embodiment, microwave radiation. is used to elute the VOCs. In another embodiment, vacuum distillation is used to elute the VOCs. Prior to heating, an anhydrous gas, for example dry nitrogen gas, may be passed through the column assembly to purge any residual water vapor prior to the elution of the VOCs. Gas may be flown through the column assembly during the heating process to assist in the removal of the eluted VOCs from the column assembly by forming an effluent containing the eluted VOCs.

Upon exiting oven 50, the VOCs may be collected using any method known in the art. In one embodiment, the VOCs are first condensed by passing the effluent containing the desorbed VOCs through a container submerged in a cold trap, wherein the VOCs are collected within the container. In a preferred embodiment, the container is submerged within a cold trap containing liquid nitrogen. The methods of the present invention allows for gravimetric measurements of the VOCs to be easily performed. By way of non-limiting example, the VOCs may be collected in a tared container in order to calculate the mass of the collected VOCs. The gravimetric measurements facilitate the quantitation of VOCs collected using the column assembly of the present invention. Upon elution and removal from the column assembly, the VOCs may be subjected to methods of detection so that they may be identified and/or quantified. The methods of the present invention may provide a significant improvement in the results obtained from methods of detection, such as GC/MS, over other methods known in the art. In some embodiments, trapping and collecting VOCs within the column assembly permits the collection of larger amounts of VOCs, resulting in improved GC separation results as well as mass spectral analyses of the VOCs. In one embodiment, a sample of the collected VOCs is subjected to a method of detection. In another embodiment, the VOCs are not collected and instead the effluent flows directly from the column assembly into the detector.

VOCs may be detected using various technologies including, but not limited to: gas chromatography (GC); spectrometry, for example mass spectrometry (including quadrapole, time of flight, tandem mass spectrometry, ion cyclotron resonance, and/or sector (magnetic and/or electrostatic)), ion mobility spectrometry, proton transfer reaction-mass spectrometry (PTR-MS), time of flight secondary ion mass spectroscopy (ToF-SIMS), field asymmetric ion mobility spectrometry, and/or DMS; fuel cell electrodes; light absorption spectroscopy; nanoparticle technology; flexural plate wave (FPW) sensors; biosensors that mimic naturally occurring cellular mechanisms; electrochemical sensors; photoacoustic equipment; laser-based equipment; electronic noses (bio-derived, surface coated); various ionization techniques; and/or trained animal detection, or any combination thereof. In one embodiment, gas chromatography/mass spectrometry is used to detect VOCs. In one embodiment, proton transfer reaction-mass spectrometry (PTR-MS) is used to detect VOCs. In one embodiment, time of flight secondary ion mass spectroscopy (ToF-SIMS) is used to detect VOCs.

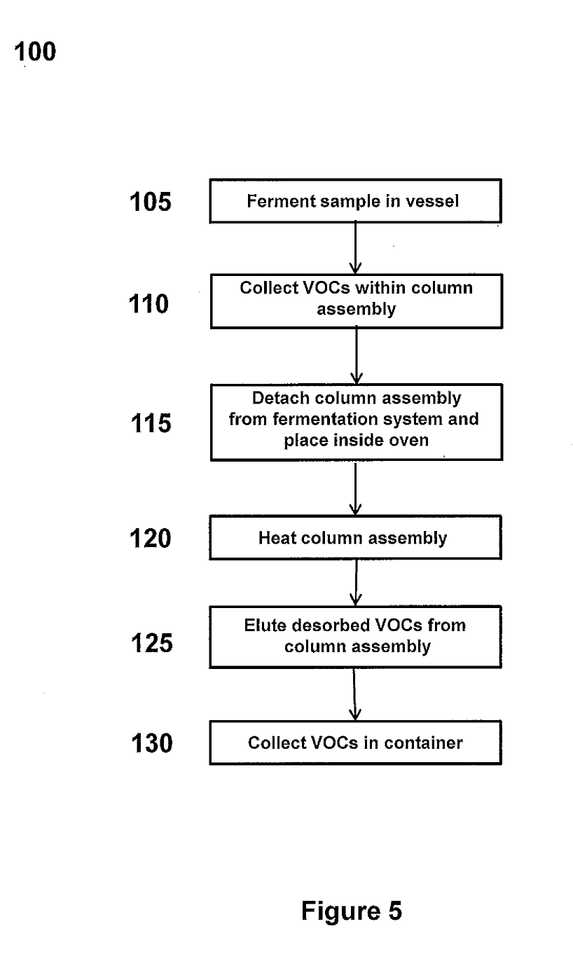

FIG. 5 describes volatile organic compounds trapping method 100 practiced in accordance with the present invention, Block 105 ferments the sample within vessel 40. Any fermentation method which produces VOCs is contemplated in the present invention. In one embodiment, the fermentation method is solid state fermentation. As depicted in FIGS. 4A and 4B, the column assembly is attached to the fermentation system. Prior to attachment of column assembly 10, vessel 40 may be purged with nitrogen gas to remove any VOCs present in the vessel head space which resulted from the fermentation broth.

Block 110 collects the VOCs within the column assembly. Gas flows through vessel 40 and pushes VOCs produced by the fermentation sample into column assembly 10. The VOCs are adsorbed onto the surface of the adsorption materials contained within column 20. Gas may be vented out of the column assembly through outlet port 33. In one embodiment, gas is flown through the assembly for at least 10 days.

Block 115 detaches column assembly 10 from the fermentation system and places it inside oven 50. Column assembly 10 may be detached at any time wherein a sufficient amount of VOCs have been adsorbed on the adsorption material and trapped within the column. Following detachment, column assembly 10 may be placed within oven 50. VOCs trapped within column assembly 10 are eluted from the column assembly through the heating of the column within oven 50 with the simultaneous flowing of gas through the column assembly, which pushes the eluted VOCs out of the column assembly. In an alternative embodiment, oven 50 may be used for the pre-conditioning of column assembly 10 prior to the trapping of VOCs by heating the column and activating the adsorption material contained within to remove any previously adsorbed VOCs.

Block 120 heats column assembly 10. The application of heat to the column assembly results in the desorption of the VOCs from the surface of the adsorption material contained within column 20. In one embodiment, column assembly 10 is heated from 30° C. to 180° C.

Block 125 elutes desorbed VOCs from column assembly 10. Gas flown through the column assembly creates an effluent containing the desorbed VOCs, which exits the column assembly through outlet port 33.

Block 130 collects VOCs in container 60. The effluent containing the desorbed VOCs is directed into container 60, which is submerged in a cooling material contained within trap 62. In one embodiment, the cooling material is liquid nitrogen. The collected VOCs may be subsequently identified through various detection methods, as would be understood by one skilled in the art. Gas may be vented out of container 60 through vent 57.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

### Example 1

### Trapping and Collecting Volatile Fungal Hydrocarbons and Hydrocarbon Derivatives

Hypoxylon sp, an endophytic fungus which has been shown to produce the important fuel compound 1,8 cineole and its related cyclohexanes, and the successful trapping, elution and analyses of certain fungal volatile organic compounds (VOCs) has been accomplished. Furthermore, a novel-laboratory trapping material, (bear paw shale-bentonite) is described as a solid phase adsorbent for trapping fungal hydrocarbons. This material was selected since it is from this and other shale formations in Montana and North Dakota that crude oil is most commonly found. Careful analysis has indicated how the shale can be used to trap fungal hydrocarbons and some explanations are given as to why it may sequester these compounds.

The selective adsorbants, Carbotraps B and C, were capable of effectively trapping significant quantities of the more non-polar of the fungal VOCs including the hydrocarbon-like molecules. In fact, desorbing with heat followed by condensation of the gases into a liquid nitrogen trap was also shown as an effective method to acquire the volatiles in amounts adequate enough (milligram quantities) to acquire other physical-chemical measurements. This process will prove useful in acquiring additional spectral data on the unknown compounds found in fungal volatiles since workable quantities of the materials were available (Table 1). Also, the method should prove useful in the selective removal of additional hydrocarbon molecules associated with the fungal broth after they are volatized with steam explosion techniques. This is not to mention the potential use of the technique for numerous other biological applications in which volatile substances are involved.

TABLE 1
A SPME Analysis of the Fungal VOCs Trapped and Collected
from a Culture of Hypoxylon sp. on the Carbotrap Materials.

| Retention | Molecular | | | |
|---|---|---|---|---|
| Time | Weight | | Quality | Abundance |
| (min) | (AMU) | Identity | (%) | (relative) |
| 2.08 | | unknown | | 7.76 |
| 6.48 | 136 | Bicyclohex-2-ene, | 91 | 0.38 |
| | | 2-methyl | | |
| 7.07 | 70 | 2-Butenal | 91 | 1.13 |
| 7.96 | 120 | Cyclohexane, 1,2,4- | 86 | 0.91 |
| | | tris(methylene)- | | |
| 8.82 | 178 | unknown | | 3.42 |
| 8.97 | 282 | unknown | | 0.54 |
| 10.02 | 178 | unknown | | 1.26 |
| 10.23 | 136 | Myrcene | 91 | 1.76 |
| 10.98 | 124 | unknown | | 0.36 |
| 11.23 | 136 | D-Limonene | 97 | 6.32 |
| 11.55 | 154 | 1,8 Cineole | 99 | 67.19 |
| 12.25 | 106 | unknown | | 0.33 |
| 12.38 | 106 | unknown | | 4.35 |
| 12.70 | 136 | unknown | | 0.23 |
| 13.33 | 134 | Benzene, 1-methyl-4-(1- | 97 | 2.65 |
| | | methylethyl) | | |
| 14.45 | 74 | unknown | | 0.27 |
| 15.73 | 118 | Benzene, 1-ethenyl-4- | 95 | 0.47 |
| | | methyl- | | |
| 16.55 | 86 | unknown | | 0.28 |
| 16.85 | 128 | unknown | | 0.55 |
| 17.12 | 118 | Benzene | 96 | 0.39 |
| 18.8 | 60 | Acetic Acid | 91 | 6.57 |
| 20.34 | 106 | Benzaldehyde | 97 | 0.47 |
| 20.76 | 84 | unknown | | 0.38 |
| 21.57 | 46 | Formic acid | 64 | 0.28 |
| 21.69 | 88 | Propanoic acid | 64 | 0.24 |
| 22.09 | 154 | 3-cyclohexen-1-ol, | 93 | 0.31 |
| | | 4-methyl | | |
| 24.32 | 154 | p-menth-1-en-8-ol | 91 | 1.4 |
| 27.96 | 170 | Oxabicyclooctanol | 97 | 0.27 |

As an aside, other trapping material, such as charcoal, had previously been tried and although it effectively removed volatile fungal products, they products did not survive the heating process for successful recovery. For this reason the Carbotrap materials were selected. It is to be noted that these materials have been prepared for the selective trapping of molecules with certain characteristics including size, charge and having other functional groups.

The use of bentonite in the system is noteworthy since virtually all of the crude oil in this particular region of Montana is associated with shale formations. If bentonite has the appropriate chemistry and physical structure to attract and hold hydrocarbons of ancient origin, then it may also be capable of the same hydrocarbon trapping when fungal volatiles are passed through it. In fact, it successfully, but non-selectively bound many of the fungal volatile products including the hydrocarbon-like substances such as the cyclohexanes, cyclohexenes, 1,8 cineole, numerous aldehydes, and other compounds.

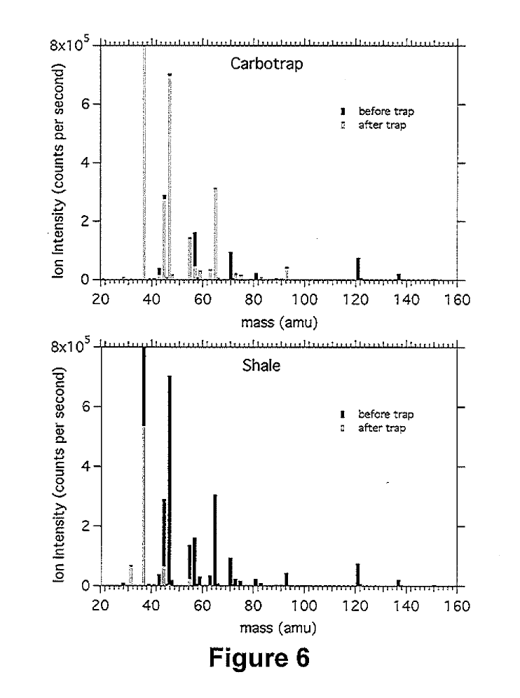

A close examination of the volatile organic products of a number of endophytic fungi revealed that their volatile products are either the principal ingredients of transportations fuels, such as regular diesel fuel, or are very close derivatives thereof. Such compounds are the cyclic and straight-chained hydrocarbons such as octane, heptane and cyclohexane followed by the benzene and naphthalene derivatives (Adams & Richmond, 1951, Anal. Chem. 23:129-133; Liang et al., 2005, J. Envorion. Monit. 7:983-988). Although not wishing to be bound by any particular theory, this result, along with a number of other arguments, are consistent with the explanation that some or all of the world's crude oil may have originated from microbial sources. Therefore, as the vast amount of organic matter in the world began the processes of decay via various microbial activities, the reduced organic products resulting from these processes may have been trapped in the numerous shales of the earth. It is from these sources that crude oil is mostly recovered. Thus, these results definitely show that the fungal volatiles have some affinity to the bentonite being tested (FIG. 6). And while there is some surface trapping of the gases, the greater volume of material is probably associated with minute pores, veins and fissures in this material.

The materials and methods employed in these experiments are now described.

### Trapping Materials

The Carbotrap materials B&C were purchased from Supelco Co. A number of Carbotrap materials are available with different volatile preferences. They were preconditioned at 250° C. for 2 hours under a flow of pure dry nitrogen gas at 1.5 L/min. The authentic standards were from Sigma Aldrich (St. Louis, Mo.). The bentonite was procured from the Musselshell River bottom in Montana in an area where oil wells exist at N 46° 58′ 4168; W 107° 54′4383°. All steel and steel fittings were purchases from McMaster-Carr (Elmhurst, Ill.).

### Carbotrap Columns

As shown in FIG. 1C, a corrosion resistant stainless steel tube (column) of 12 cm×2.2 cm was prepared having a well fitted collet at each end. Stainless steel was selected since it is relatively non-reactive, heat tolerant and not providing sources of contamination. End caps for the column were milled with a metal lathe and milling machine in order to provide a gas tight seal at the ends of the column. A center hole of 6 mm was drilled and ⅛ in Swagelok™ fittings were TIG welded to the caps. The tube's center housed a fine wire mesh screen effectively separating the column into two compartments. The screen was held in place by two snap rings inserted on either side of the barrier. For the Carbotrap material column, Carbotrap materials B&C (Supelco, Bellefonte, Pa.) were placed into each compartment respectfully. These materials were selected because of their trapping specificity for hydrocarbons and hydrocarbon derivatives. These well described materials by Supelco are commonly used in therma-desorption tubes with direct input into GC/MS systems. They have been adopted for use herein as semi-preparative column materials. For the bentonite column where bentonite was used as the adsorbent, a slightly longer column was constructed containing 40 g of bentonite particles (0.40-0.80 mm). Since these particles were essentially homogeneous, there was no need for the internal screen divider.

Prior to use, the trap was preconditioned at 250° C. for several hours under a constant flow of nitrogen gas at 650 cc per min. The cooled column was then attached to a system for trapping VOCs. Short stainless steel lines and Tygon tubing connected the column to the fungal headspace. During sample collection using the Carbotrap column, the gas stream was first directed through the Carbotrap C material to preferentially trap higher molecular weight VOCs, followed by the Carbotrap B material to trap smaller molecular weight substances.

Once trapping was completed, each column was placed in a specifically designed temperature programmable oven. A stainless steel rack held the metal column, while entry and exit ports allowed dry nitrogen gas to enter the column and nitrogen laden with fungal hydrocarbons to exit the oven for subsequent condensation. Dry purging of the column was performed for at least 2-3 hours at 30 C in the presence of a flow of nitrogen at 50 ml per min in order to remove any water vapor that may have accumulated from the fungal culture. In the case of the bentonite column, dry purging was done for 16-24 hours under the same conditions. Elution of volatile substances was performed by gently raising the oven temperature to 180 C in the presence of a pure dry nitrogen at 65 cc per min with the subsequent effluent being immediately directed to a 30 ml vial submersed in liquid nitrogen. The elution period was 60 min.

The overall yield efficiency of the Carbotrap and the bentonite columns was ascertained by several methods. Initial tests were conducted by placing a known amount of 1,8 cineole (90 mg) in a 250 ml glass bottle appropriately fitted with stainless steel valves and tubing. Then, dry nitrogen was passed through the bottle for two hours into the trapping device. This effectively simulated the collection of hydrocarbons from a culture bottle. A gravimetric measurement was made on the column before and after the compound was trapped. In addition, the actual amount of material recovered after exposure of the effluent to liquid nitrogen was measured. In this manner both the effectiveness of the column and the efficiency of the recovery processes could be ascertained. PTR mass spectral measurements were also made to evaluate the trapping efficiency of VOCs from a fungal culture, Hypoxylon sp., known to produce energy rich compounds of interest, using both the bentonite and Carbotrap materials as traps (Tomsheck et al., 2010, Microbial Ecology 60:903-914).

### Growing Hypoxylon Sp for Gas Analysis

A 10 L bottle containing 7 L of potato dextrose (PD) broth was incubated a 22° C. at 120 rpm shaking. Following incubation the flask was continuously purged with particle free air filtered air (filtered with a Pall-Acro-50 filter at 0.2 microns) at 800 ml per min (FIG. 4B). After the flask was purged with compressed air for at least 3-4 days, it was inoculated with 100 ml of a slurry of a 5-7 day old fungal inoculum consisting mostly of mycelial fragments. The initial purging removed most of the volatile ingredients of the PD broth. After inoculation, the outflow of the flask was directed through a Teflon tube directly into the stainless steel column trap that contained either the Carbotrap materials or bentonite (FIG. 4B). The incubation proceeded for the next 10 days during which all of the purge gas and the fungal VOCs were passed through the trap.

### Qualitative Analyses of Endophytic Culture Volatiles

Analysis of gases in the air space in the 30 ml trapping vial was performed after gentle warming of the vial (having trapped hydrocarbons from Hypoxylon sp.) by a stable flex fiber technique (Strobel et al., 2001, Microbiology 147:2943-2950). This was done in order to learn if the column could successfully trap and yield hydrocarbons of a well-established gas producing fungus (Tomsheck et al., 2010, Microbial Ecology 60:903-914). First, a baked “Solid Phase Micro Extraction” syringe (Supelco, Bellefonte, Pa.) consisting of 50/30 divinylbenzene/carboxen on polydimethylsiloxane on a Stable Flex fiber was inserted into the vial through the septum and exposed to the vapor for only 15 sec due to the high concentration of fungal volatiles. The syringe was then inserted into the splitless injection port of a Hewlett Packard 6890 gas chromatograph containing a 30 m×0.25 mm I.D. ZB Wax capillary column with a film thickness of 0.50 μm. The column was temperature programmed as follows: 30° C. for 2 min increased to 220° C. at 5° C. min⁻¹. The carrier gas was ultra-high purity helium, and the initial column head pressure was 50 kPa. Prior to trapping the volatiles, the fiber was conditioned at 240° C. for 20 min under a flow of helium gas. A 30 sec injection time was used to introduce the sample fiber into the GC. The gas chromatograph was interfaced to a Hewlett Packard 5973 mass selective detector (mass spectrometer) operating at unit resolution. The MS was scanned at a rate of 2.5 scans per second over a mass range of 35-360 amu. Data acquisition and data processing were performed on the Hewlett Packard ChemStation software system. Tentative identification of the compounds produced by the fungus was made via library comparison using the NIST database, and all chemical compounds described herein use the NIST database chemical terminology. The compounds were compared to those trapped with the SPME fiber when exposed to a fungus culture itself (Tomsheck et al., 2010, Microbial Ecology 60:903-914). Compounds that are listed have at least an 80% quality score, indicating a high likelihood of product identity. Final confirmatory identification was made for any compounds with available authentic standards by comparing the GC/MS data of the standards, including 1-8-cineole and others as indicated, with the GC/MS data of fungal products.

### Scanning Electron Microscopy

Scanning electron microscopy (SEM) was performed on small platelet samples that were mounted on stubs, coated with gold, and examined with an FEI XL30 ESEM FEG scanning electron microscope (SEM) and also in high-vacuum mode using an EDAX Genisis energy dispersive x-ray analyzer.

Quantification of Fungal Volatiles Before and after Passage Through the Column

Proton transfer reaction-mass spectrometry (PTR-MS) was used to determine the effectiveness of the gas trapping materials. The PTR/MS was used to measure the concentration of volatiles, produced by Hypoxylon sp., entering the trapping column and the concentration of volatiles in the gas stream exiting the column at a time when the culture was in maximum gas production at 6-7 days (Lindinger et al., 1998; Tomsheck et al., 2010, Microbial Ecology 60:903-914). The PTR-MS instrument ionizes organic molecules in the gas phase through their reaction with H₃O⁺, forming mostly protonated molecules (MH⁺, where M is the neutral organic molecule) which can then be detected by a standard quadrupole mass spectrometer. This process can be run on real air samples with or without dilution, since the primary constituents of air (nitrogen, oxygen, argon and carbon dioxide) have a proton affinity less than water and thus are not ionized. Most organic molecules (excepting alkanes, per se) have a proton affinity greater than water and are therefore ionized and detected (Lindinger et al., 1998).

A further advantage of PTR-MS is that the absolute concentration of the constituents in the sample can be quantified from the measured ion intensities using the known reaction time and the theoretical reaction rate constant for the proton transfer reaction (Lindinger et al., 1988, Int. J. Mass Spectrom Ion Process 173:191-241). Finally, an enormous advantage of PTR-MS is that it can be run in real time and continuously to produce data on the concentrations of specific ions of interest (Lindinger et al., 1988, hit. J. Mass Spectrom Ion Process 173:191-241; Ezra et al., 2004, Plant Science 166:1471-1477). Several PTR-MS measurements were made with comparable results. This method is one of the best techniques to measure fungal volatiles (Ezra et al., 2004, Plant Science 166:1471-1477; Strobel et al., 2008, Microbiology 154:3319-3328). The SPME technique has some limitations when used with complex samples containing VOCs with very different physical properties due to the differential adsorption efficiencies of the VOCs on the SPME fiber and thus cannot be accurately used in a quantitative manner. Therefore, an estimate of the quantities the volatile components could be obtained by the PTR-MS technique before and after passage through a trapping column.

PTR/MS measurements were made on gases from the fungal culture before and after entering a trapping column. An uninoculated flask containing PD broth was used as a control. The tests were run with a drift tube temperature of 0° C. and drift tube pressure of 2.05 mbar with and electric field strength to number density ratio (EN) of 136 td. Sampling was performed by flowing 750 ml min⁻¹ of nitrogen through the culture bottles. The outflow from the culture bottles or the traps was then directed to the inlet of the PTR-MS, which samples a portion of the gas flow. The sample lines were constructed entirely from PFA Teflon tubing and stainless steel fittings. Mass spectral scans were acquired from 20 to 225 Da. A minimum of 10 mass spectral scans was obtained for each sample. Concentrations obtained from the PTR-MS measurements were calculated using equations derived from reaction kinetics and assume that a reaction rate coefficient of 2×10⁻⁹ ml s⁻¹ is appropriate for all compounds (Lindinger et al., 1988, Int. J. Mass Spectrom Ion Process 173:191-241). The VOC concentration produced by the fungal culture is taken as the difference between the endophyte and the control measurements and all other considerations as those described by Thomsheck et al., 2010. This value reflects only the contribution from those species having proton affinities greater than that of water which is assumed to represent virtually all of the VOCs since the SPME technique did not allow identification of any components that would not be expected to be detectable by the PTR-MS (Tomsheck et al., 2010, Microbial Ecology 60:903-914). PTR/MS data are presented for both the Carbotrap and bentonite materials used in the column and reflect the differences between the volatiles before and after the columns were connected to the outflow from the fungal fermentation flask.

### TOF-SIMS Analysis of Hydrocarbon Absorbed Bentonite Particles

In order to examine the possibility that fungal hydrocarbons were adsorbed to the surfaces on the shale particles they were subjected to time of flight secondary ion mass spectroscopy (ToF-SIMS) analysis. Shale samples were prepared by the protocol described in the text and then were pressed on a clean indium foil. Analyses of samples were carried out with a Phi-Evans TRIFT 1 mass spectrometer. The working principle of this system has been reported elsewhere (Avci et al., 1999, Surf. Interface Anal. 27:789-796). In all ToF-SIMS acquisitions, static SIMS requirements were observed; i.e. the primary ion dose remained below 10¹³ ions per cm². A beam of low-energy (<20 eV) electrons was fired intermittently to prevent charging of the sample. The mass resolution, m/Δm, was ˜3000 when the primary Ga⁺ beam was bunched and was ˜1500 when it was unbunched to increase ion image resolution. The data acquisition and analysis were carried out employing Win-Cadence ToF-SIMS software (Physical Electronics, Minneapolis, Minn.). This method generally observes molecules adhering to physical surfaces as a monolayer or submonolayer.

The results of the experiments are now described.

### Gravimetric Determination of the Efficiency Trapping and Recovery of 1,8 Cineole

Under the test conditions described, the Carbotrap material was capable of collecting 93% (by weight) of the 1,8 cineole applied, in the gas phase, to the column. Then, when the column was heated and the gases condensed in liquid nitrogen, as described above, a recovery of 63.5 mg of 1,8 cineole was achieved in the liquid nitrogen trap for a recovery of 70% of the starting material. However, in the case of bentonite, only 25 mg of the initial 90 mg of 1,8 cineole that had been applied to the column was observed with a final recovery of 17 mg for a total of 18%. With this efficiency, it appeared that the Carbotrap materials have potential for making measurements of fungal hydrocarbon production.

Analysis of Fungal VOCs Recovered with the Carbotrap

A fermentation flask was inoculated with Hypoxylon sp as described above (FIG. 4B). After trapping with the Carbotrap materials, heat desorption and condensation in liquid nitrogen, there was recovery of 75 mg of a material appearing as a yellowish liquid at 23° C. This material, when subjected to GC/MS, yielded many hydrocarbon-like compounds including 1,8 cineole and cyclohexane, 1,2,4-tris(methylene)—which are some of the main products detected in gas phase of fungal cultures (Tomsheck et al., 2010, Microbial Ecology 60:903-914; Table 1). However, other monoterpenes also appeared including bicyclohex-2-ene, 2-methyl, limonene and myrcene (Table 1). As with the analysis of the fungal culture gases, there were also many unidentified compounds (Tomsheck et al., 2010, Microbial Ecology 60:903-914). While substantial quantities of 1,8 cineole were recovered, in other experiments, up to a total of 147 mg of fungal volatiles were trapped, collected, and analyzed with comparable results. Accordingly, the methods presented herein may also be useful in determining if and when certain compounds are produced in the fermentation cycle. This can easily be done by removing the trap at a particular time and desorbing it while a fresh one is put in place.

Trapping of Fungal Volatiles with Bentonite

Bentonite (bear paw shale) (40 g) was activated as per the Carbotrap materials and placed in the trap column and fungal gases were passed through it for 10 days. After trapping however, at least 18 hours at 30° C. were allowed for the dry purge since this material is so hygroscopic. At least 53.5 mg of fungal VOCs were recovered from this material after a 10 day incubation/trapping period. Bentonite appears to be non-selective in its trapping of organic substances and a myriad of fungal products were detected in the trapping vial including 1,8 cineole and a plethora of minor components including aldehydes, alcohols, cyclohexene derivatives, and phenylethyl alcohol. Although bentonite can trap fungal VOCS it is not selective, and its capacity is limited. Nevertheless, the material in nature has effectively trapped biologically based hydrocarbons (crude oil) simply because there is so much of it in massive deposits thousands of meters thick.

### PTR/MS Experiments

As an independent method for determining the relative efficiencies of the Carbotrap and Bentonite materials, PTR-MS measurements were made on a fungal culture at the prime time of gas production (Tomsheck et al., 2010, Microbial Ecology 60:903-914). The spectra measurements, where the mass spectra (the response expressed in concentration), were obtained after the traps have been superimposed onto the mass spectra recorded directly from the fungal culture (FIG. 6). Where possible, the major ions have been annotated and identified (FIG. 6). Two ions, m/z 37 and m/z 55, result from the hydration of the primary H₃O+ reagent ion and correspond to H₃O+(H₂O)1,2. Ethanol and acetaldehyde are seen to be the predominate volatiles. Ethanol is observed at m/z 47, m/z 65 and m/z 93, which represents the protonated molecule (RH⁺), its hydrate RH+(H₂O), and the proton bound dimer (RH+R). Acetaldehyde is observed at m/z 45 (RH⁺). The ions at m/z 137 and m/z 81 are characteristic of 1,8 cineole and the monoterpenes (Tomsheck et al., 2010, Microbial Ecology 60:903-914), while the ion at m/z 121 infers the presence of a component or components with a molecular weight of 120, several of which were identified via the SPME measurements (Table 1). The mass spectral results obtained in this present study are consistent with those previously reported for Hypoxylon sp. with only a few minor differences in the product ion distribution (Tomsheck et al., 2010, Microbial Ecology 60:903-914).

The difference in the trapping characteristics of the Carbotrap materials and the benonite shale is readily apparent (FIG. 6). The Carbotrap materials are selective and efficiently retain the higher molecular weight fungal volatiles while showing no affinity towards the volatile ethanol and acetaldehyde components (FIG. 6). The Carbotrap materials trap better than 99% of the higher molecular weight (m/z 81, m/z 121 and m/z 137) materials representing approximately 20% of all of the fungal volatiles. The bentonite is a less selective trap and retains both water and the fungal volatiles. The trapping capacity of bentonite is limited and the fungal volatiles begin to break though within minutes of operating the trap. These observations are consistent with the gravimetric measurements of the trapping efficiency of the Carbotrap and bentonite trapping materials when used in the column and 1,8 cineole was used as test material, as previously described.

### Properties of the Bentonite Shale

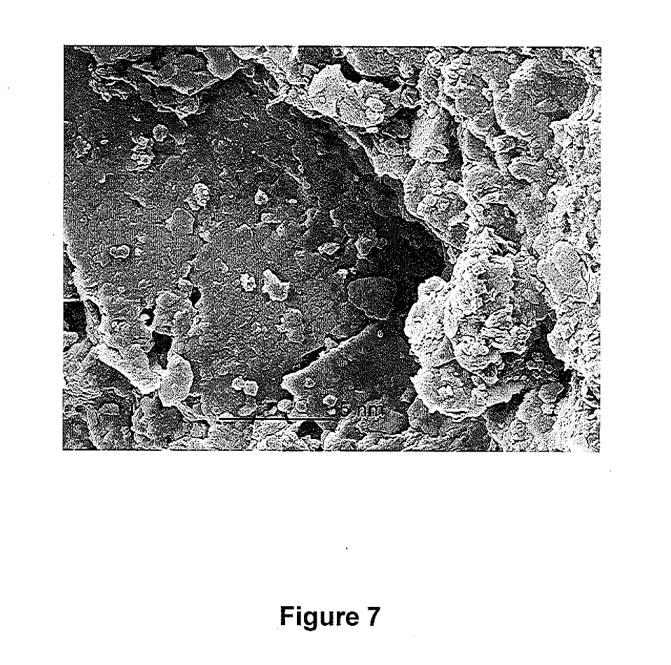

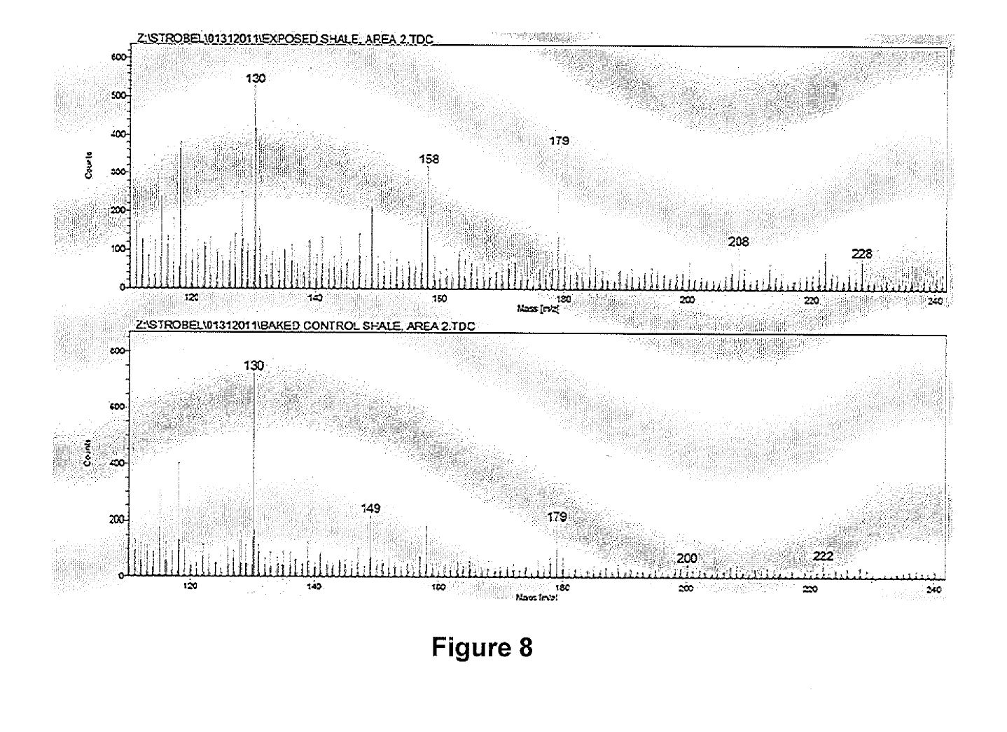

Since the bentonite-shale, a naturally occurring material, was trapping some of the fungal products including 1,8 cineole and the cyclohexanes, it was of interest to learn more about this substance which is in great abundance in many regions of the world where oil is found. The bentonite used in these experiments was composed elementally of silicon and aluminum with smaller amounts of magnesium, sodium, iron sulfur, potassium and even smaller levels of titanium and calcium. The material is organized into small plates that appear in layers (FIG. 7). When the bentonite was fully adsorbed with fungal volatiles it was examined by ToFSIMS. An appropriate control bentonite that had not been adsorbed with fungal gases (heat treated) was also examined. A comparison of the positive ions of the organic molecules observed by ToFSIMS in the mass region from 1 amu to 1000 amu of both samples revealed that the two spectra look qualitatively very similar. Examples of two ToFSIMS spectra (from 110-240) indicate that both possess ions at each amu and no new peaks appear in the fungal sample (FIG. 8). Generally, small increases in the peak intensities were expected in the fungal sample given the broad range of VOCs that appeared in the condensate after heat elution of the bentonite. It appears that the surfaces of the bentonite particles were mostly saturated with organic substances even before exposure to the fungal gases, but some additional materials were absorbed, however the surface absorbing phenomenon seemed unlikely to account for all of the volatiles trapped by the bentonite. Hence, most of the fungal gasses that were trapped by the shale particles must reside deep into the particle matrix and are no longer available to the ToFSIMS probe. This is most likely the case since prolonged exposure of a fully absorbed bentonite at 10⁻⁴ Torr vacuum for 2 hours removed 0.8% of the weight and then an additional 0.4% of the weight was removed upon heating at 180° C., under a stream of nitrogen gas. Although not wishing to be bound by any particular theory, these results suggest that channels or other fissures in the bentonite particles are the likely locations in which the trapped fungal VOCs are residing.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A device for trapping volatile compounds, comprising:
a column having an inner chamber separated into at least two compartments; and
at least two different adsorption materials;
wherein each of the at least two compartments of the column contains one of the at least two different adsorption materials.

2. The device of claim 1, wherein the at least two compartments are aligned sequentially, such that when a sample containing a volatile compound is passed through the inner chamber of the column, the sample passes through each compartment sequentially.

3. The device of claim 2, wherein one of the at least two different adsorption materials is carbon black.

4. The device of claim 2, wherein one of the at least two different adsorption materials is Carbotrap C.

5. The device of claim 4, wherein one of the at least two different adsorption materials is Carbotrap B.

6. The device of claim 5, wherein the Carbotrap C material is placed within the column upstream of the Carbotrap B material, such that when a sample containing a volatile compound is passed through the inner chamber of the column, the sample first contacts the Carbotrap C material and subsequently contacts the Carbotrap B material.

7. The device of claim 2, wherein each compartment is separated by a screen.

8. The device of claim 1, wherein the volatile compound is a volatile organic compound (VOC) produced by a microorganism.

9. The device of claim 8, wherein the VOC is a hydrocarbon or hydrocarbon derivative.

10. A system for trapping and collecting volatile compounds, comprising:
a trapping column including at least one adsorption material positioned within a lumen of the trapping column;
an oven for heating the trapping column; and
a cold-trap condenser;
wherein, when a sample containing at least one volatile compound is passed through the lumen of the trapping column, the at least one volatile compound is captured on or in the at least one adsorption material; and
wherein the captured at least one volatile compound is released from the trapping column by simultaneously heating the column in the oven while a gas is pushed through the lumen of the column, and collecting the at least one volatile compound released from the trapping column in the cold-trap condenser.

11. The system of claim 10, wherein the column is heated in the oven to at least 50 C.

12. The system of claim 10, wherein the cold-trap condenser is cooled to at least 0° C.

13. The system of claim 10, wherein the yield of collected volatile compound is at least 10% of the amount of volatile compound initially passing through the trapping column.

14. The system of claim 10, wherein the at least one volatile compound is a VOC produced by a microorganism.

15. The system of claim 14, wherein the VOC is produced via liquid phase fermentation.

16. The system of claim 14, wherein the VOC is produced via solid phase fermentation.

17. A method of trapping and collecting volatile compounds, comprising:
passing a sample having at least one volatile compound through a column containing at least one adsorption material;
trapping the at least one volatile compound on or in the at least one adsorption material;
passing a gas through the column while simultaneously heating the column to release the at least one volatile compound from the adsorption material; and
collecting the at least one volatile compound released from the adsorption material in a cold-trap condenser.

18. The method of claim 17, wherein the column is heated in the oven to at least 50° C.

19. The method of claim 17, wherein the cold-trap condenser is cooled to at least 0° C.

20. The method of claim 17, wherein the yield of collected volatile compound is at least 10% of the amount of volatile compound initially passing through the trapping column.
